(19) United States
(12) Patent Application Publication
(10) Pub. No.: US 2026/0019526 A1
(43) Pub. Date: Jan. 15, 2026

(54) IMAGE FORMING APPARATUS, HANDLING METHOD, AND NON-TRANSITORY COMPUTER-READABLE RECORDING MEDIUM

(71) Applicant: Takuma TAKAMIZAWA, Kanagawa (JP)

(72) Inventor: Takuma TAKAMIZAWA, Kanagawa (JP)

(73) Assignee: Ricoh Company, Ltd., Tokyo (JP)

(21) Appl. No.: 19/230,522

(22) Filed: Jun. 6, 2025

(30) Foreign Application Priority Data
Jul. 12, 2024 (JP) 2024-112356

(51) Int. Cl. H04N 1/60; H04N 1/00

(52) U.S. Cl. CPC H04N 1/6033; H04N 1/00045; H04N 2201/0094

(57) ABSTRACT

An image forming apparatus includes an engine and circuitry that stores a verification condition including an evaluation item for color reproducibility verification, a tolerance value, an evaluation chart, and color information of an intended printing standard. The circuitry calculates an evaluation result for the item based on a color measurement value of the chart and the color information and compares the evaluation result with the tolerance value to generate a determination result indicating pass or fail. The circuitry stores the determination result and number of determinations for the condition; and a handling method to resolve an issue that has caused the verification under the condition to fail, for a case where 10 the verification has never passed, and for a case where the verification has passed. The circuitry determines a handling method for the item when the item fails, based on the information, and notifies a user of the method.

### CROSS-REFERENCE TO RELATED APPLICATION

This patent application is based on and claims priority pursuant to 35 U.S.C. §119(a) to Japanese Patent Application No. 2024-112356, filed on Jul. 12, 2024, in the Japan Patent Office, the entire disclosure of which is hereby incorporated by reference herein.

### BACKGROUND

### Technical Field

The present disclosure relates to an image forming apparatus, a handing method, and a non-transitory recording medium.

### Related Art

One approach to printing quality checks involves verifying whether the colors of print standards—Japan Color, Fogra, and GRACoL—are reproduced based on differences, including color difference, chromaticity difference, and hue difference. Such an approach is common for evaluating color reproducibility in various certification systems for assessing whether the printing quality satisfies a predetermined standard. To confirm that the printing quality satisfies the standard, printing companies often conduct quality checks based on evaluation criteria or evaluation items compliant with various certification systems.

When all the evaluation items meet the standards, there is no issue. However, when one or more evaluation items fail to meet the standards, re-evaluation is necessary after addressing the issue. Addressing the issue requires expert knowledge of colors and image quality. Users who are not able to address the issue themselves need to call the manufacturer's support or take other measures, which require time and effort to resolve.

### SUMMARY

The present disclosure described herein provides an image forming apparatus including an image forming engine and circuitry. The image forming engine outputs an image. The circuitry stores, in a memory, a verification condition including an evaluation item for color reproducibility verification, a tolerance value for the evaluation item, an evaluation chart, and color information of an intended printing standard. The circuitry calculates an evaluation result for the evaluation item based on a color measurement value of the evaluation chart and the color information of the intended printing standard. The circuitry compares the calculated evaluation result with the tolerance value to generate a determination result indicating pass or fail. The circuitry stores, in the memory, the determination result and number of determinations for the verification condition. The circuitry stores, in the memory, a handling method for the evaluation item to resolve an issue that has caused the color reproducibility verification under the verification condition to fail, for a case in which the color reproducibility verification under the verification condition has never passed, and for a case in which the color reproducibility verification under the verification condition has passed once or more before. The circuitry determines a handling method for the evaluation item when the evaluation item fails, based on the stored information. The circuitry notifies a user of the determined handling method.

The present disclosure described herein provides a method of determining a handling method. The method of determining includes storing an evaluation item, calculating, comparing, storing a result, storing a handling method, determining, and notifying. The storing includes storing, in a memory, an evaluation item for color reproducibility verification, a tolerance value for the evaluation item, an evaluation chart, and color information of an intended printing standard. The calculating includes calculating an evaluation result for the evaluation item based on a color measurement value of the evaluation chart and the color information of the intended printing standard. The comparing includes comparing the calculated evaluation result with the tolerance value to generate a determination result indicating pass or fail. The storing a result includes storing, in the memory, the determination result and number of determinations for a verification condition for the color reproducibility verification. The storing a handling method includes storing, in the memory, a handling method for the evaluation item to resolve an issue that has caused the color reproducibility verification under the verification condition to fail, for a case in which the color reproducibility verification under the verification condition has never passed, and for a case in which the color reproducibility verification under the verification condition has passed once or more before. The determining includes determining a handling method for the evaluation item when the evaluation item fails, based on the stored information. The notifying includes notifying a user of the determined handling method.

The present disclosure described herein provides a non-transitory recording medium storing a plurality of instructions which, when executed by one or more processors, causes the one or more processors to perform a handling method. The method includes storing an evaluation item, calculating, comparing, storing a result, storing a handling method, determining, and notifying. The storing includes storing, in a memory, an evaluation item for color reproducibility verification, a tolerance value for the evaluation item, an evaluation chart, and color information of an intended printing standard. The calculating includes calculating an evaluation result for the evaluation item based on a color measurement value of the evaluation chart and the color information of the intended printing standard. The comparing includes comparing the calculated evaluation result with the tolerance value to generate a determination result indicating pass or fail. The storing a result includes storing, in the memory, the determination result and number of determinations for a verification condition for the color reproducibility verification. The storing a handling method includes storing, in the memory, a handling method for the evaluation item to resolve an issue that has caused the color reproducibility verification under the verification condition to fail, for a case in which the color reproducibility verification under the verification condition has never passed, and for a case in which the color reproducibility verification under the verification condition has passed once or more before. The determining includes determining a handling method for the evaluation item when the evaluation item fails, based on the stored information. The notifying includes notifying a user of the determined handling method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a schematic configuration of an image forming apparatus;

FIG. 2 is a block diagram illustrating a hardware configuration of an image forming apparatus;

FIG. 3 is a diagram illustrating a functional configuration of a digital front end (DFE);

FIGS. 4A to 4D are diagrams each illustrating data stored in a color reproducibility verification data storage unit;

FIG. 5 is a diagram illustrating a color reproducibility verification result displayed on an image forming apparatus;

FIG. 6 is a diagram illustrating methods for handling failed evaluation items displayed on an image forming apparatus;

FIGS. 7A and 7B are diagrams each illustrating data stored in a handling method storage unit of a DFE;

FIG. 8 is a diagram illustrating the selection of a handling mode on an image forming apparatus;

FIG. 9 is a diagram illustrating data stored in a determination result storage unit of a DFE;

FIG. 10A is a flowchart of a handling process performed by an image forming apparatus; and FIG. 10B is a continuation of the flowchart of FIG. 10A.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

In the following description, suffixes Y, M, C, and K denote colors of yellow, magenta, cyan, and black, respectively. To simplify the description, these suffixes are omitted unless necessary.

An image forming apparatus, a handling method, and a program are described below in detail with reference to the accompanying drawings.

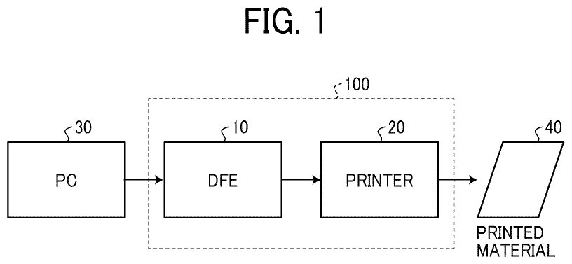

FIG. 1 is a block diagram illustrating a schematic configuration of an image forming apparatus 100. The image forming apparatus 100 is an example of an image forming apparatus that outputs a desired image corresponding to image information, which is an example of input image data. As illustrated in FIG. 1, the image forming apparatus 100 includes a DFE 10 as a controller and a printer 20 that are connected to each other.

The DFE 10 communicates with the printer 20 and controls the image formation by the printer 20.

A personal computer (PC) 30 is connected to the DFE 10. The DFE 10 may be connected to the PC 30 via a network. The PC 30 generates image information described in a language, such as a page description language (PDL), by a pre-installed application and transmits the generated image information to the DFE 10. The DFE 10 converts the image information described in a language, such as PDL, into image data rendered in a format printable by the printer 20 and transmits the image data to the printer 20. The DFE 10 has a hardware configuration that includes a central processing unit (CPU) to control the entire apparatus; main memory, such as read-only memory (ROM) and random-access memory (RAM), for storing various data and programs; and auxiliary storage, such as a hard disk drive (HDD), for additional data and program storage. The DFE 10 has a hardware configuration that employs a standard computer. Processing in the DFE 10 is implemented by the CPU of the DFE 10 executing various programs stored in the main memory and auxiliary storage. Alternatively, these functions can also be implemented using individual circuits (hardware).

The printer 20 is equipped with at least one color of colorant, such as cyan, magenta, yellow, and black colorants. The printer 20 includes an image forming unit and a fixing assembly to fix the colorants. The printer 20 forms and fixes an image with a colorant according to image data transmitted from the DFE 10. As a result, an image is formed on a recording medium, and a desired printed material 40 is acquired.

The image forming apparatus 100 may be implemented simply by the DFE 10 or the printer 20. The printer 20 may be an electrophotographic printer with toner or an inkjet printer with ink.

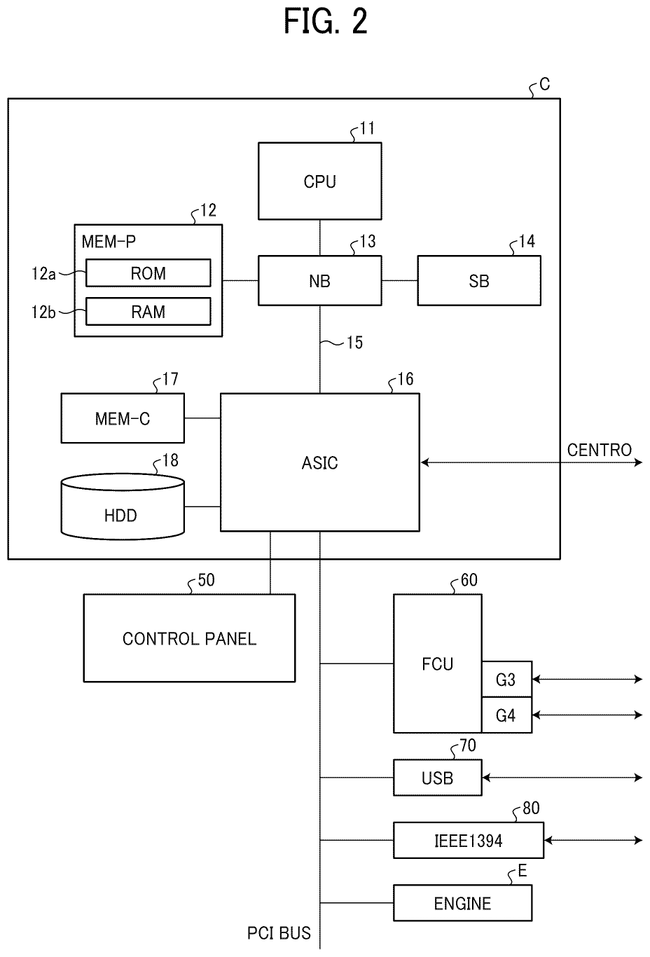

FIG. 2 is a block diagram illustrating a hardware configuration of the image forming apparatus 100.

As illustrated in FIG. 2, the image forming apparatus 100 includes a controller C and an engine E that are connected to each other via a Peripheral Component Interconnect (PCI) bus. The controller C controls the entire image forming apparatus 100, rendering, communication, and input from an operation unit. The engine E is, for example, a printer engine that is connectable to the PCI bus, such as an electrophotographic printer or an inkjet printer. The engine E is an example of an image forming engine that outputs an image.

The controller C includes a CPU 11, a north bridge (NB) 13, a system memory (MEM-P) 12, a south bridge (SB) 14, a local memory (MEM-C) 17, an application-specific integrated circuit (ASIC) 16, and an HDD 18. The NB 13 and the ASIC 16 are connected to each other via an accelerated graphics port (AGP) bus 15. The MEM-P 12 includes a ROM 12a and a RAM 12b.

The CPU 11 controls the overall operation of the image forming apparatus 100. The CPU 11 has a chipset including the NB 13, the MEM-P 12, and the SB 14, and is connected to other devices through the chipset. The NB 13 is a bridge that connects the CPU 11 with the MEM-P 12, the SB 14, and the AGP bus 15. The NB 13 includes a memory controller that controls the reading or writing of data to or from the MEM-P 12, as well as a PCI master and an AGP target.

The MEM-P 12 is system memory used for purposes such as storing programs and data, expanding programs and data, and rendering for a printer. As described above, the MEM-P 12 includes the ROM 12a and the RAM 12b. The ROM 12a is a read-only memory used as a memory for storing programs and data. The RAM 12b is a readable and writable memory used, for example, as a memory for expanding programs and data, and as a memory for rendering in a printer.

The SB 14 is a bridge that connects the NB 13 with a PCI device or a peripheral device. The SB 14 is connected to the NB 13 via the PCI bus. This PCI bus also connects to, for example, a network interface (I/F) unit.

The ASIC 16 is an integrated circuit (IC) for image processing applications, including hardware components for image processing, and functions as a bridge that connects the AGP bus 15, the PCI bus, the HDD 18, and the MEM-C 17. The ASIC 16 includes a PCI target, an AGP master, an arbiter (ARB) that serves as the core of the ASIC 16, a memory controller that controls the MEM-C 17, multiple direct memory access controllers (DMACs) that perform operations, including rotation of image data by hardware logic, and a PCI unit that performs data transfer with the engine E via the PCI bus. A facsimile control unit (FCU) 60 compliant with Group 3 (G3) and Group 4 (G4) facsimile standards, a Universal Serial Bus (USB) 70, and an Institute of Electrical and Electronics Engineers 1394 (IEEE 1394) interface 80 are connected to the ASIC 16 via the PCI bus. A control panel 50 is directly connected to the ASIC 16.

The MEM-C 17 is a local memory used as a copy image buffer and a code buffer. The HDD 18 is a storage device for storing image data, programs, font data, and forms.

The AGP bus 15 is a bus interface for a graphics accelerator card, which has been proposed to accelerate graphics processing. By enabling high-throughput direct access to the MEM-P 12, the AGP bus 15 enhances the performance of the graphics accelerator card.

The present embodiment is implemented by executing a program on the CPU 11, with necessary data for the program being stored in the RAM 12b or similar memory. The hardware configuration illustrated in FIG. 2 is an example, and the configuration may be any configuration that can implement the present embodiment.

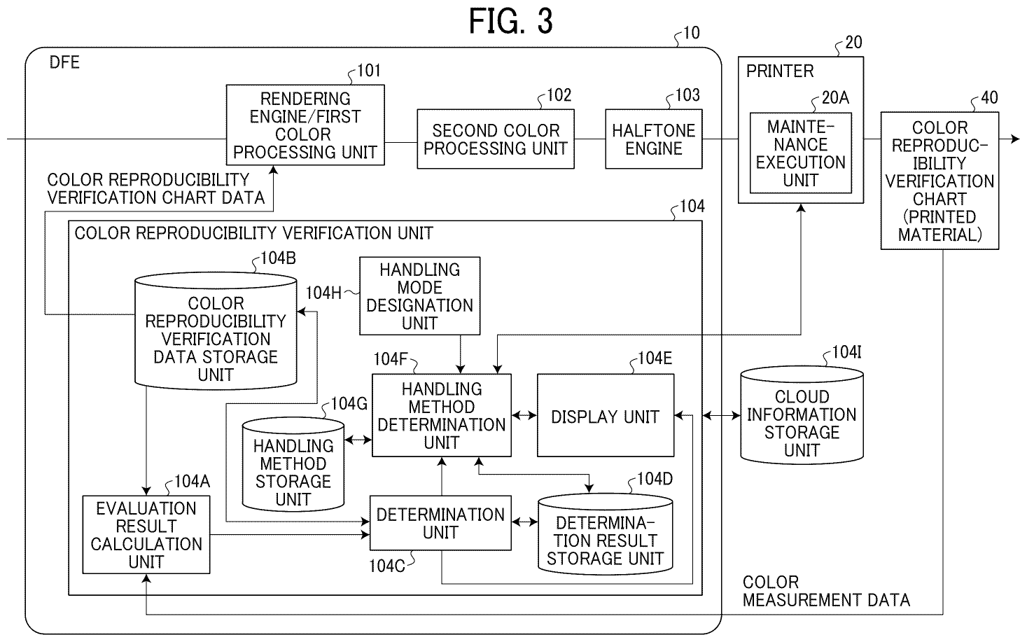

FIG. 3 is a diagram illustrating a functional configuration of the DFE 10. As illustrated in FIG. 3, the DFE 10 includes a rendering engine/first color processing unit 101, a second color processing unit 102, a halftone engine 103, and a color reproducibility verification unit 104. The rendering engine/first color processing unit 101 performs operations on an electronic document generated by the PC 30, including language interpretation, vector or raster conversion (with a rendering resolution of, for example, 1200 dpi), and color conversion to process colors, such as cyan, magenta, yellow, and black (CMYK).

The second color processing unit 102 performs operations, including gradation correction for calibration and total amount regulation for limiting the total amount of colorants. The halftone engine 103 converts 8-bit data for each color into image data format of the printer 20 (e.g., 2-bit data) and transmits the converted image data to the printer 20.

The color reproducibility verification unit 104 is described below in detail. Firstly, an outline of the color reproducibility verification is described below. The user designates a sheet, a printer, and a verification condition for color reproducibility verification, and issues an instruction to execute the color reproducibility verification. The sheet is an example of a recording medium. In response to the user instruction, the color reproducibility verification unit 104 performs the color reproducibility verification and handles failed items. The verification condition collectively includes target color information, an evaluation chart used for verification, a determination criterion, and information of a colorimeter used for color measurement of the evaluation chart. The target color information is the color information of an intended printing standard. The verification condition may be registered and retained for each combination of the target color information, the evaluation chart, the determination criterion, and the colorimeter information.

The target color information includes various standards, such as Japan Color 2011 Coated, GRACoL2013, and Fogra51, and specifies device-independent color information in L*a*b* corresponding to device-dependent CMYK combinations. Such standards are common in the printing industry as standards for printing colors. Other than the standards for printing colors, user-customized target color information may be used for the color reproducibility verification.

For example, in a case where the output color L*a*b* corresponding to the CMYK combination of the printer 20 on a certain day is set as the target color information and it is verified whether the output color of the printer 20 on the day and thereafter matches the target color information, the user-customized target color information is to be used. The evaluation chart and the determination criterion used for the verification are typically an evaluation chart and a determination criterion used in various certification systems for evaluation of, for example, the printing quality. Alternatively, a user-customized evaluation chart or determination criterion may be used.

Since the evaluation items and the quality level to be emphasized are different depending on the user, the color reproducibility verification that matches the user's desire can be performed by using the customized evaluation chart and determination criterion.

The determination criterion includes an evaluation item for color reproducibility verification and a tolerance value (acceptance criterion) for the evaluation item. The color reproducibility verification determines whether the verification passes or fails by comparing the tolerance value for the evaluation item with the result obtained from the color measurement value of the color reproducibility verification chart. When the color reproducibility verification fails, typically, the color reproducibility verification is performed again after addressing the issue, and the main printing is performed after the color reproducibility verification passes.

Secondly, the functions of the color reproducibility verification unit 104 are described below. As illustrated in FIG. 3, the color reproducibility verification unit 104 includes an evaluation result calculation unit 104A, a color reproducibility verification data storage unit 104B, a determination unit 104C, a determination result storage unit 104D, a display unit 104E, a handling method determination unit 104F, a handling method storage unit 104G, and a handling mode designation unit 104H. When the user designates the sheet, the printer 20, and the verification condition for color reproducibility verification, and issues an instruction to execute the color reproducibility verification, the color reproducibility verification unit 104 issues an instruction to print color reproducibility verification chart data associated with the verification condition. The color reproducibility verification chart data includes a patch group in which CMYK values are variously combined. Whether the target color is reproduced is verified by printing and measuring the colors of the patch group. In response to the print instruction, the rendering engine/first color processing unit 101 performs color conversion on the color reproducibility verification chart data using a target color reference profile associated with the verification condition and an output profile suitable for the sheet. Then, the second color processing unit 102 and the halftone engine 103 process the color-converted data, and the printer 20 prints the processed data. The color of each patch on the printed color reproducibility verification chart is measured by a colorimeter, and the color measurement data is transmitted to the evaluation result calculation unit 104A. The printed color reproducibility verification chart is an example of the printed material 40 and may be referred to as color reproducibility verification chart (printed material) 40 in the following description. The color measurement may be performed by an in-line sensor built in the printer 20 at the same time as printing, by an external colorimeter, or by an external system and the color measurement data may be imported.

The color reproducibility verification data storage unit 104B is an example of a color reproducibility verification data storage unit that stores a verification condition including one or more evaluation items for color reproducibility verification, a tolerance value for each evaluation item, an evaluation chart, and target color information. The target color information is an example of color information of an intended printing standard. Each verification condition includes the image forming apparatus 100, a sheet, one or more evaluation items, a tolerance value for each evaluation item, an evaluation chart, and target color information. By storing a verification condition for each of the combinations with different color reproducibility, the image forming apparatus 100 can appropriately determine whether the verification has never passed or has passed before.

The evaluation result calculation unit 104A calculates an evaluation result for each evaluation item specified by the determination criterion, based on the determination criterion, the evaluation chart, and the target color information associated with the verification condition acquired from the color reproducibility verification data storage unit 104B, as well as the color measurement data (color measurement values) of the color reproducibility verification chart (printed material) 40. The evaluation result calculation unit 104A then transmits the calculated evaluation result to the determination unit 104C. In other words, the evaluation result calculation unit 104A is an example of an evaluation result calculating unit that calculates an evaluation result for each evaluation item based on the color measurement values of the evaluation chart and the target color information.

The determination unit 104C compares the received evaluation result for each evaluation item with the tolerance value acquired for each evaluation item from the color reproducibility verification data storage unit 104B, determines pass or fail for each evaluation item, stores the determination result in the determination result storage unit 104D, and instructs the display unit 104E to display the determination result. When one or more evaluation items fail, the determination unit 104C instructs the handling method determination unit 104F to determine a handling method. In other words, the determination unit 104C is an example of a determination unit that compares the calculated evaluation result with the tolerance value and determines pass or fail. The determination result storage unit 104D is an example of a determination result storage unit that stores a result of determination by the determination unit 104C and the number of determinations for each verification condition for color reproducibility verification.

The handling method storage unit 104G is an example of a handling method storage unit that stores, for each evaluation item, a handling method to resolve an issue that has caused the color reproducibility verification under the verification condition to fail, for a case in which the color reproducibility verification under the verification condition has never passed, and for a case in which the color reproducibility verification under the verification condition has passed once or more before. The handling method storage unit 104G may further store, for each evaluation item, information on the number of times each handling method is performed, the number of resolutions, and the solution contribution rate. The handling method storage unit 104G may further store the processing time for each handling method. The handling method storage unit 104G may further store a manufacturer's recommended order of handling methods for each evaluation item.

The handling method determination unit 104F references past determination results for the sheet, the printer, and the verification condition stored in the determination result storage unit 104D. When the past determination results indicate that the verification has never passed before, the handling method determination unit 104F acquires, for each evaluation item, a handling method without a pass history from the handling method storage unit 104G and determines a handling method for each failed item. When the past determination results indicate that the verification has passed once or more before, the handling method determination unit 104F acquires, for each evaluation item, a handling method with a pass history from the handling method storage unit 104G and determines a handling method for each failed item. In other words, the handling method determination unit 104F is an example of a handling method determination unit that determines a handling method for a failed evaluation item based on the information stored in the determination result storage unit 104D and the information stored in the handling method storage unit 104G. The display unit 104E is an example of a handling method display unit that notifies a user of the handling method determined by the handling method determination unit 104F. Accordingly, handling methods suitable for failed evaluation items can be appropriately suggested based on the situation (whether the verification has never passed or has passed before). In a case where failed evaluation items are not resolved even when all the handling methods are performed, the display unit 104E may display a message recommending contact with a service of the manufacturer of the image forming apparatus 100. Accordingly, the issues that cannot be handled on the user side can be resolved by contacting, for example, the service of the manufacturer.

When multiple handling methods are found, the handling method determination unit 104F may determine a handling method recommended by the manufacturer as the handling method. The issues can be handled efficiently by preferentially performing the handling method recommended by the manufacturer. Alternatively, when multiple handling methods are found, the handling method determination unit 104F may determine a handling method based on a mode designated through the handling mode designation unit 104H. Since the user can switch the handling modes, the issues can be handled to meet the customer's requirements.

The printer 20 includes a maintenance execution unit 20A, which is an example of a maintenance execution unit that executes a maintenance process to resolve an issue causing a failure. When the handling method determined by the handling method determination unit 104F is a maintenance process executable by the printer 20, the maintenance execution unit 20A executes the maintenance process to resolve the issue. Thus, when the handling method is executable by the image forming apparatus 100, the image forming apparatus 100 executes the handling method. The handling method determination unit 104F may function as an example of a maintenance execution setting unit that presets, when the handling method is a maintenance process executable by the maintenance execution unit 20A, whether to automatically execute the maintenance process or to execute the maintenance process in response to a user instruction indicating whether to execute the maintenance process. In this case, the maintenance execution unit 20A may execute the maintenance process according to a setting by the handling method determination unit 104F, the setting indicating whether to automatically execute the maintenance process or to execute the maintenance process in response to a user instruction indicating whether to execute the maintenance process. This enables the switching between automatically executing the handling method and determining whether to execute the handling method after checking the handling method.

Since the appropriate handling method varies, the handling method is changed according to whether the verification has passed before. For example, when the verification has never passed, it is highly likely that no color adjustment has been performed to acquire appropriate color reproducibility in the first place, and that generating an output profile is one of the appropriate handling methods. By contrast, when the verification has passed once or more, it is highly likely that the color variation of the machine occurring after the successful verification is the cause of the failure, and that calibration is one of the appropriate handling methods.

When multiple handling methods are found, a method recommended by the manufacturer may be preferentially performed, a method with a shorter adjustment time may be preferentially performed, or a method with a higher solution contribution rate may be preferentially performed based on the number of times each handling method is performed, the number of resolutions, and the solution contribution rate stored in the handling method storage unit 104G for each evaluation item. In other words, when multiple handling methods are found, the handling method determination unit 104F may determine, as the handling method, a handling method recommended by the manufacturer according to a manufacturer's recommended order of the handling methods. When multiple handling methods are found, the handling method determination unit 104F may determine a handling method with a shorter processing time as the handling method. The issues can be handled in a short time by preferentially performing the handling method with a shorter processing time. When multiple handling methods are found, the handling method determination unit 104F may determine a handling method with a higher solution contribution rate as the handling method. The issues can be handled efficiently by preferentially performing the handling method with a higher possibility of resolution.

The user may designate, through the handling mode designation unit 104H, how to determine a handling method from multiple handling methods. In other words, the handling mode designation unit 104H is an example of a handling mode designation unit that allows a user to designate a handling mode in advance to determine a handling method when multiple handling methods are found. In this case, when multiple handling methods are found, the handling method determination unit 104F may determine a handling method based on the handling mode designated through the handling mode designation unit 104H.

When the user confirms the determination results displayed on the display unit 104E and issues an instruction to handle failed items, the handling method determination unit 104F instructs the display unit 104E to display the handling methods.

The failed items that can be handled by the image forming apparatus 100 are handled either automatically or in response to an execution instruction from the user. For the failed items that cannot be handled by the image forming apparatus 100, the display unit 104E displays the handling methods to prompt the user to handle the failed items. When all the failed items can be handled by the image forming apparatus 100, the image forming apparatus 100 automatically handles the failed items after displaying the determination results, without receiving an execution instruction from the user. After that, the image forming apparatus 100 may automatically perform the color reproducibility verification again. The handling method determination unit 104F instructs the maintenance execution unit 20A to execute a maintenance process for an item to be handled by the printer 20 among the failed items that can be handled by the image forming apparatus 100. For a handling method to be executed by the DFE 10, such as calibration, the handling method determination unit 104F instructs the DFE 10 to execute the handling method to handle the failed item. After all the failed items are handled, the color reproducibility verification is performed again to confirm that all the evaluation items pass.

As illustrated in FIG. 3, a cloud information storage unit 1041 may be provided on a cloud to store various types of information, such as the information stored in the color reproducibility verification data storage unit 104B, the determination result storage unit 104D, and the handling method storage unit 104G, as cloud information. By storing information on the cloud, data sharing with other individuals of the same model increases the amount of information, enabling the determination of a handling method with a higher contribution rate and allowing for unified management of color reproducibility verification results of the same model or different models to monitor the situation. Specifically, the cloud information storage unit 1041 may function as an example of a cloud information storage unit that stores, on the cloud, the number of times each handling method is performed, the number of resolutions, and the solution contribution rate. In this case, the handling method determination unit 104F may acquire, from the cloud information storage unit 1041, the data of the same model as the model of the image forming apparatus 100 subjected to the color reproducibility verification, such as the number of times each handling method is performed, the number of resolutions, and the solution contribution rate, to determine a handling method based on the acquired data. Thus, data sharing with other individuals of the same model increases the amount of information, enabling the determination of a handling method with a more accurate solution contribution rate.

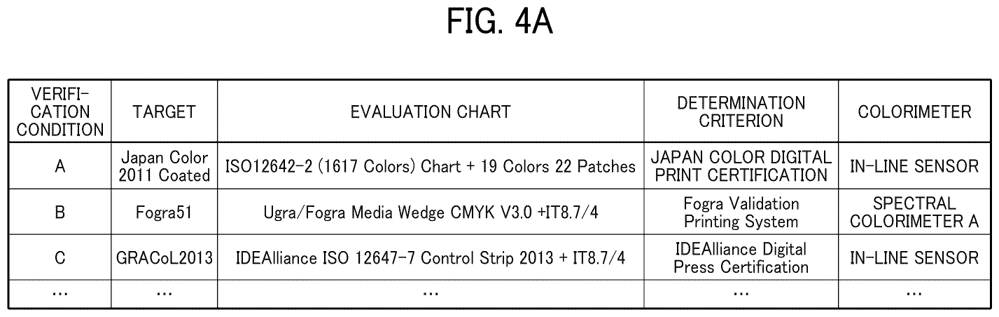

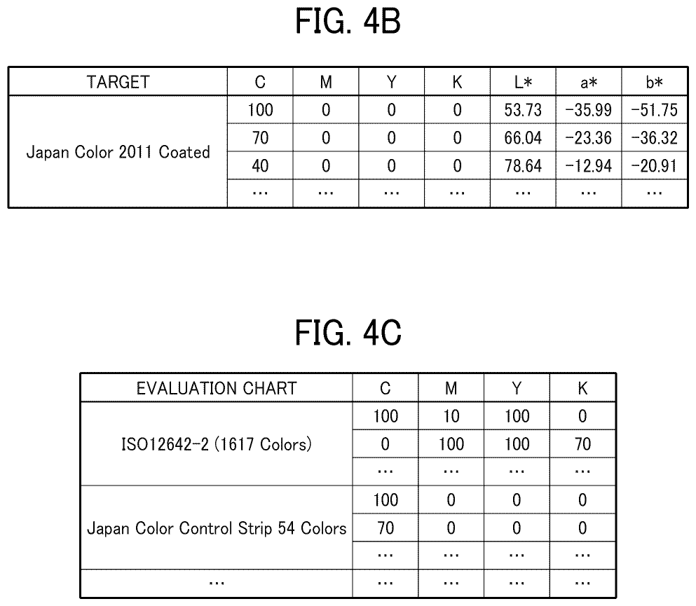

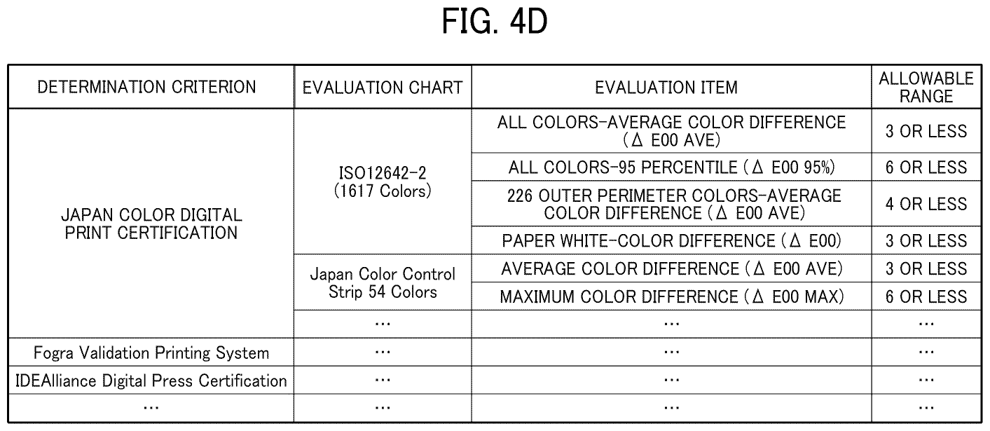

FIGS. 4A to 4D are diagrams each illustrating data stored in the color reproducibility verification data storage unit 104B. Specifically, FIG. 4A illustrates target color information, an evaluation chart, a determination criterion, and a colorimeter that are collectively registered and stored for each verification condition in the color reproducibility verification data storage unit 104B. The items included in each verification condition can be registered and stored in any combination according to the verification condition for color reproducibility verification desired by the user. However, since the evaluation chart corresponding to the determination criterion is often predetermined, only the corresponding combination is preferably registered. When the patches necessary for the evaluation of the determination criterion are not included in the evaluation chart and are insufficient, the data of the insufficient patches may be excluded from calculating the results of evaluation items.

FIG. 4B illustrates what kind of information is included in each piece of target color information. Each target color information includes L*a*b* information (L*a*b* values) corresponding to various CMYK patches. Accordingly, the target L*a*b* values for each CMYK patch in the color reproducibility verification chart (printed material) 40 are ascertained, and the result of whether the image forming apparatus 100 successfully reproduces the color can be calculated together with the L*a*b* values when the image forming apparatus 100 outputs the color.

FIG. 4C illustrates information on the CMYK patch group included in each evaluation chart. The evaluation chart may be, for example, a chart of a color configuration conforming to International Organization for Standardization (ISO) standards, a chart of a color configuration uniquely specified by various certification systems, or a custom chart registered by a user. For color reproducibility verification, the evaluation chart is printed in a layout that can be measured by a colorimeter. The evaluation chart may be generated and printed each time from the information of the CMYK patch group in accordance with the colorimeter and the sheet size to be used, or the print data of the evaluation chart for each combination may be retained in advance and used at the time of printing.

FIG. 4D illustrates evaluation charts, evaluation items, and allowable ranges for each determination criterion. The determination unit 104C references these pieces of information for each determination criterion to calculate the determination result for each evaluation item from the L*a*b* values of each patch of the target and the L*a*b* values of the corresponding patch output and measured by the image forming apparatus 100. The allowable range may be specified by various certification systems, or a user-customized allowable range may be used for the color reproducibility verification.

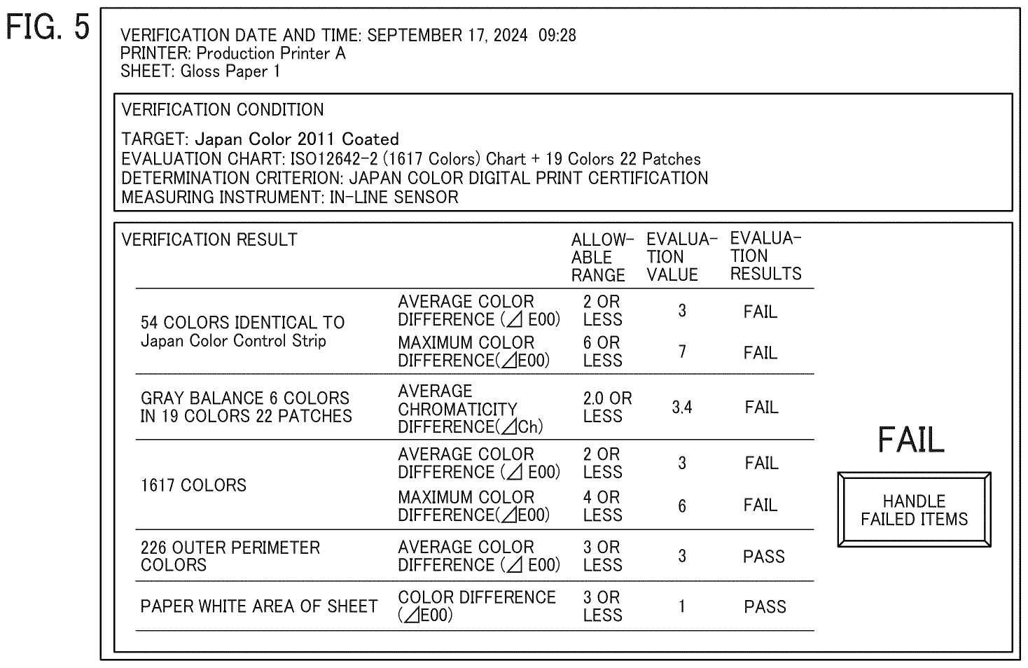

FIG. 5 is a diagram illustrating a color reproducibility verification result displayed on the image forming apparatus 100. The color reproducibility verification result illustrated in FIG. 5 includes the date and time when the color reproducibility verification is performed, the printer 20 and the sheet used for the color reproducibility verification, the verification condition including the target color information; the evaluation chart; the determination criterion; and the measuring instrument, and a verification result for each evaluation item specified by the determination criterion.

The items illustrated in FIG. 5 are examples, and other information may be displayed. For example, as printer-related information, the serial number of the printer 20, the controller in use, the raster image processor (RIP) in use for color conversion, and various types of version information may be displayed. The displayed verification condition may include a halftone screen or settings of various types of image processing. The verification result illustrated in FIG. 5 includes allowable ranges for each verification item, evaluation values calculated from the measurement data and the target color information, evaluation results obtained by comparing the evaluation values with the allowable ranges, and a comprehensive result. However, the verification result to be displayed is not limited thereto. For example, information such as the target color information and measurement data for each color patch in the evaluation chart and color differences calculated from the target color information and measurement data may be displayed, or information on a color patch that is a specific cause of failure may be displayed.

When the verification result indicates “failed,” a key indicating “handle failed items” is displayed to prompt the user to instruct the image forming apparatus 100 to handle the failed evaluation items. When all the methods for handling the failed evaluation items are executable by the image forming apparatus 100, the image forming apparatus 100 may automatically perform the handling methods after displaying the determination result, without receiving an execution instruction from the user, and automatically perform the color reproducibility verification again. The verification result may be printed as a report or stored as a file.

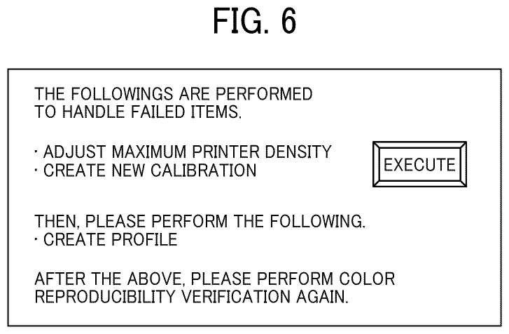

FIG. 6 is a diagram illustrating methods for handling failed evaluation items displayed on the image forming apparatus 100. In response to an instruction for performing the methods for handling failed evaluation items based on the color reproducibility verification result, the image forming apparatus 100 displays one or more handling methods executable by the printer 20 and one or more handling methods that cannot be performed by the printer 20 and need to be performed by the user. After performing the handling methods, the image forming apparatus 100 may display, for example, a message to prompt the user to instruct the color reproducibility verification again.

The printer 20 may perform the handling methods executable by the printer 20 either automatically or in response to an execution instruction from the user, for example, through a key that receives the execution instruction.

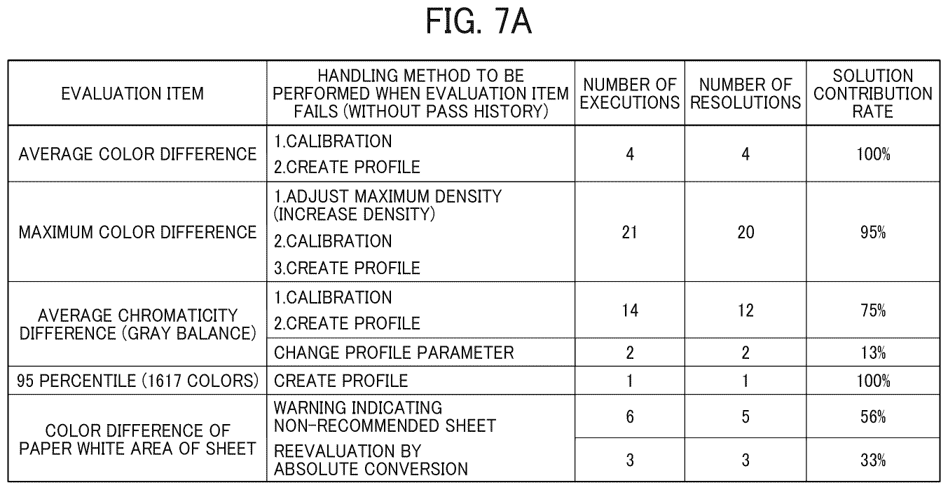

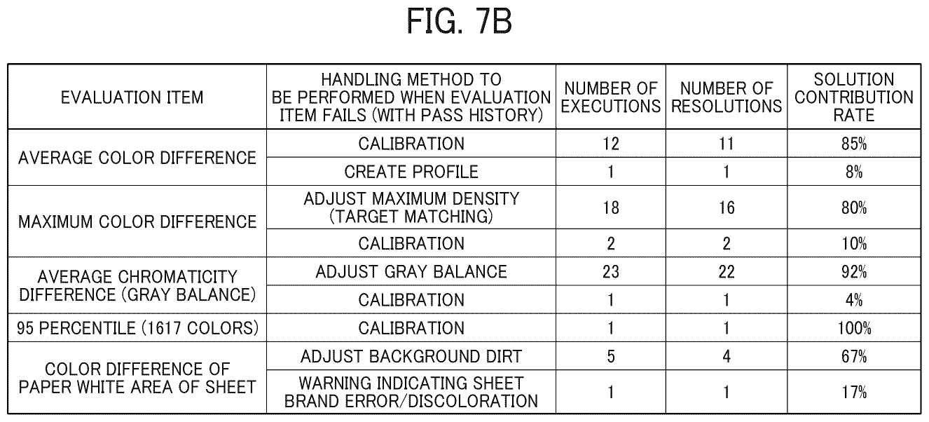

FIGS. 7A and 7B are diagrams each illustrating data stored in the handling method storage unit 104G of the DFE 10. The handling method storage unit 104G stores methods to be performed for each evaluation item when the evaluation item fails, depending on whether a pass history is present or absent for the verification condition. As described above, since the appropriate handling method varies, the handling method is changed according to whether the verification has passed before.

FIG. 7A illustrates handling methods that are referenced when no pass history is present for the verification condition. When the verification has never passed under the verification condition, it is highly likely that no color adjustment has been performed to acquire appropriate color reproducibility in the first place, and that generating an output profile is one of the appropriate handling methods. Thus, the main handling methods include generating an output profile.

FIG. 7B illustrates handling methods that are referenced when a pass history is present for the verification condition. When the verification has passed once or more under the verification condition, it is highly likely that the color variation of the machine occurring after the successful verification is the cause of the failure, and that calibration is one of the appropriate handling methods. Thus, the main handling methods include calibration. Since multiple handling methods may be found for a single evaluation item, the image forming apparatus 100 may store the number of times each handling method is performed when the evaluation item fails, the number of resolutions achieved, and the solution contribution rate calculated from the number of times each handling method is performed and the number of resolutions achieved, to try the handling methods in order from the handling method with a higher solution contribution rate. The number of times each handling method is performed, the number of resolutions, and the solution contribution rate may be separately stored for each condition for color reproducibility verification, such as the printer 20 and the sheet, or may be collectively stored for each evaluation item.

The handling method determination unit 104F determines methods for handling failed evaluation items with reference to the tables as illustrated in FIGS. 7A and 7B, and automatically performs the determined methods when the methods are executable by the image forming apparatus 100.

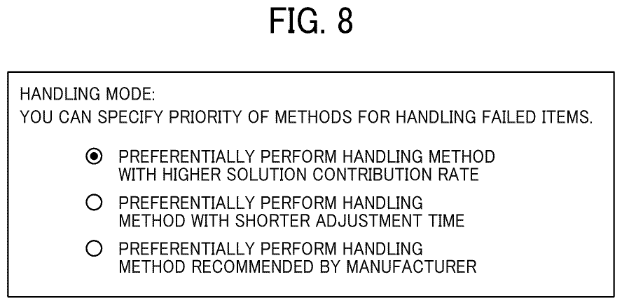

FIG. 8 is a diagram illustrating the selection of a handling mode on the image forming apparatus 100. When the order of performing the handling methods is determined based on the solution contribution rate, only a handling method with a higher solution contribution rate may be finally performed. Even the handling method with a higher solution contribution rate may require significant time for adjustments, resulting in a longer handling period. To prevent such a situation, a handling method with a shorter adjustment time may be preferentially performed, or a handling method recommended by the manufacturer may be preferentially performed regardless of the contribution rate or the adjustment time. By allowing user selection of a handling mode as illustrated in FIG. 8, the failure can be handled according to the user's needs.

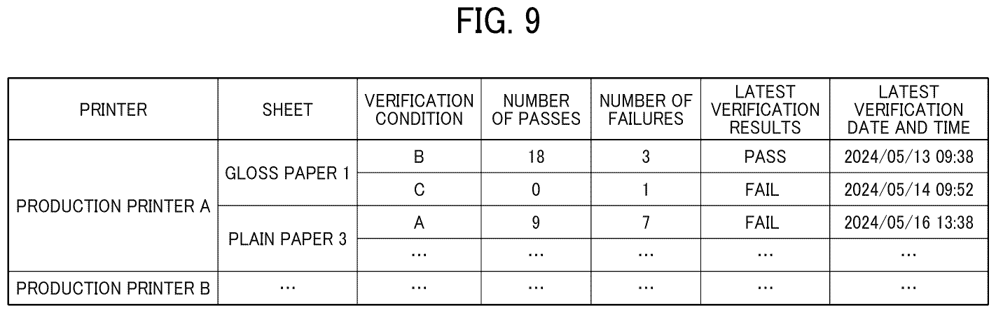

FIG. 9 is a diagram illustrating data stored in the determination result storage unit 104D of the DFE 10. Each time the color reproducibility verification is performed, the determination result storage unit 104D stores the number of passes and the number of failures for each combination of the printer 20, the sheet, and the verification condition. The determination result storage unit 104D may store the presence or absence of pass history, instead of the number of passes and the number of failures. In this case, the handling method determination unit 104F determines whether a pass history is present for the condition and changes the handling methods to be referenced. As the data to be stored, information such as the latest verification result and the latest verification date and time may be stored, or the verification result, the verification date and time, and the details of the result may be stored each time and referenced.

In FIG. 9, verification with Production Printer A, Gloss Paper 1, and Verification Condition B has a pass history. Verification with Production Printer A, Plain Paper 3, and Verification Condition A also has a pass history. Therefore, when one or more evaluation items fail as a result of the color reproducibility verification under these conditions, the handling methods with a pass history are referenced. By contrast, verification with Production Printer A, Gloss Paper 1, and Verification Condition C has no pass history. Therefore, when one or more evaluation items fail as a result of color reproducibility verification under this condition, the handling methods without a pass history are referenced.

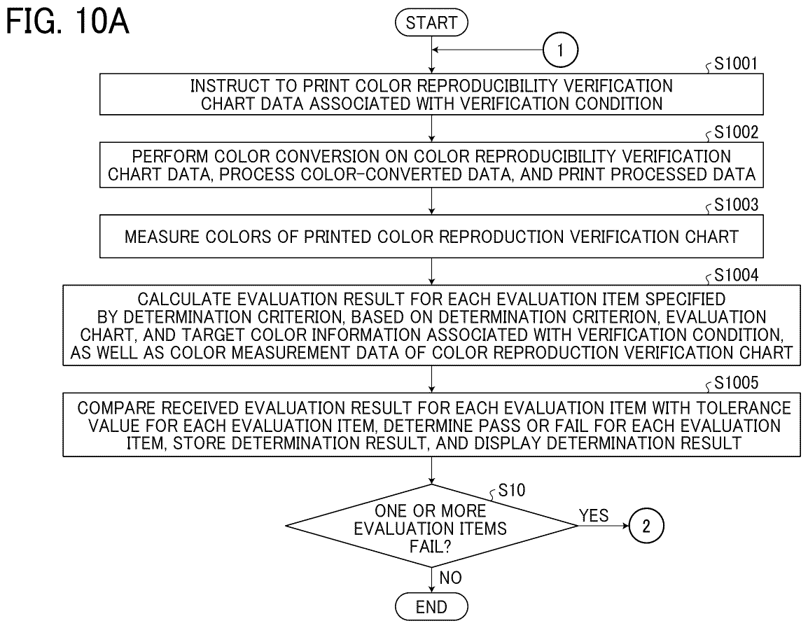

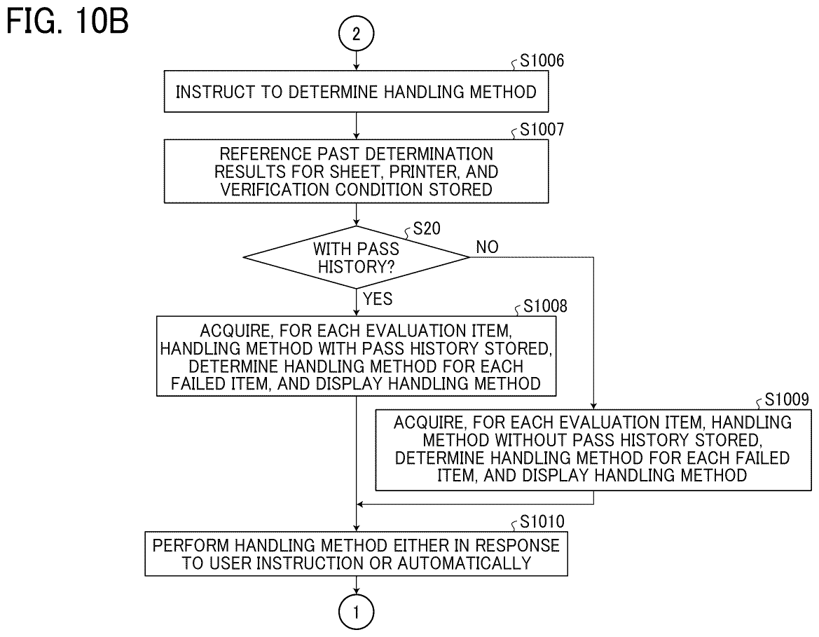

FIG. 10A is a flowchart of a handling process performed by the image forming apparatus 100. FIG. 10B is a continuation of the flowchart of FIG. 10A. When the user designates the sheet, the printer 20, and the verification condition for color reproducibility verification and issues an instruction to execute the color reproducibility verification, in step S1001, the color reproducibility verification unit 104 issues an instruction to print color reproducibility verification chart data associated with the verification condition.

In step S1002, the rendering engine/first color processing unit 101 of the DFE 10 performs color conversion on the color reproducibility verification chart data, the second color processing unit 102 and the halftone engine 103 process the color-converted data, and the printer 20 prints the processed data. In step S1003, an in-line sensor built in the printer 20; an external colorimeter of the DFE 10, the printer 20, or the PC 30; or an external system measures the colors of the printed color reproducibility verification chart (printed material) 40 and transmits the color measurement data to the evaluation result calculation unit 104A.

In step S1004, the evaluation result calculation unit 104A calculates an evaluation result for each evaluation item specified by the determination criterion, based on the determination criterion, the evaluation chart, and the target color information associated with the verification condition acquired from the color reproducibility verification data storage unit 104B, as well as the color measurement data of the color reproducibility verification chart. The evaluation result calculation unit 104A then transmits the calculated evaluation result to the determination unit 104C. In step S1005, the determination unit 104C compares the received evaluation result for each evaluation item with the tolerance value acquired for each evaluation item from the color reproducibility verification data storage unit 104B, determines pass or fail for each evaluation item, stores the determination result in the determination result storage unit 104D, and instructs the display unit 104E to display the determination result.

When one or more evaluation items fail (YES in step S10), in step S1006, the determination unit 104C instructs the handling method determination unit 104F to determine a handling method.

In step S1007, the handling method determination unit 104F references past determination results for the sheet, the printer, and the verification condition stored in the determination result storage unit 104D.

When the past determination results indicate that the verification has passed once or more before (YES in step S20), in step S1008, the handling method determination unit 104F acquires, for each evaluation item, a handling method with a pass history from the handling method storage unit 104G, determines a handling method for each failed item, and instructs the display unit 104E to display the handling method.

When the past determination results indicate that the verification has never passed before (NO in step S20), in step S1009, the handling method determination unit 104F acquires, for each evaluation item, a handling method without a pass history from the handling method storage unit 104G, determines a handling method for each failed item, and instructs the display unit 104E to display the handling method.

In step S1010, the handling method determination unit 104F instructs the maintenance execution unit 20A or the DFE 10 to perform the handling method either in response to a user instruction or automatically, and the maintenance execution unit 20A or the DFE 10 perform the handling method accordingly, or the user performs the handling method when the handling method cannot be performed by the image forming apparatus 100. After that, the process returns to step S1001 to perform the color reproducibility verification again.

Since the actual printing is typically performed after addressing all the failures in the color reproducibility verification, the color reproducibility verification is often performed again after performing methods for handling the failures. However, the color reproducibility verification may be optionally performed again after performing methods for handling the failures. When all the evaluation items pass (NO in step S10), the process illustrated in FIGS. 10A and 10B ends.

As described above, the image forming apparatus 100 presents a solution (handling method) suitable for a failed evaluation item according to the situation and automatically performs the handling method when the image forming apparatus 100 can handle the failure by performing the handling method, allowing a user without expertise to resolve the failed evaluation item.

The program executed by the image forming apparatus 100 is pre-installed in ROM or similar media and provided. The program executed by the image forming apparatus 100 may be recorded in a file format that is either installable or executable by a computer, on a computer-readable recording medium, such as a compact disc-read-only memory (CD-ROM), a flexible disk (FD), a compact disc-recordable (CD-R), or a digital versatile disk (DVD).

The program executed by the image forming apparatus 100 may be stored on a computer connected to a network, such as the Internet, and provided by allowing the programs to be downloaded through the network. The program executed by the image forming apparatus 100 may be provided or distributed through a network, such as the Internet.

The program executed by the image forming apparatus 100 is configured as multiple modules, each including one or more of the aforementioned units, such as the rendering engine/first color processing unit 101, the second color processing unit 102, the halftone engine 103, and the color reproducibility verification unit 104. In actual hardware, a processor, such as the CPU 11, reads and executes the program from the ROM 12a to load the aforementioned units into the main memory, thereby generating the rendering engine/first color processing unit 101, the second color processing unit 102, the halftone engine 103, and the color reproducibility verification unit 104 in the main memory.

The image forming apparatus has been described as a multifunction peripheral (MFP) having at least two of copying, printing, scanning, and facsimile functions. However, the present disclosure can be applied to any image forming apparatus, such as a copier, printer, scanner, or facsimile machine.

A description is given below of several aspects of the present disclosure.

According to a first aspect, an image forming apparatus that outputs a desired image corresponding to input image data includes a color reproducibility verification data storage unit, an evaluation result calculation unit, a determination unit, a determination result storage unit, a handling method storage unit, a handling method determination unit, and a handling method display unit. The color reproducibility verification data storage unit stores a verification condition including one or more evaluation items for color reproducibility verification, a tolerance value for each evaluation item, an evaluation chart, and color information of an intended printing standard. The evaluation result calculation unit calculates an evaluation result for each evaluation item based on a color measurement value of the evaluation chart and the color information of the intended printing standard. The determination unit compares the calculated evaluation result with the tolerance value and determines pass or fail. The determination result storage unit stores a result of determination by the determination unit and the number of determinations for each verification condition. The handling method storage unit stores, for each evaluation item, a handling method to resolve an issue that has caused the color reproducibility verification under the verification condition to fail, for a case in which the color reproducibility verification under the verification condition has never passed, and for a case in which the color reproducibility verification under the verification condition has passed once or more before. The handling method determination unit determines a handling method for a failed evaluation item based on the information stored in the determination result storage unit and the information stored in the handling method storage unit. The handling method display unit notifies a user of the handling method determined by the handling method determination unit.

According to a second aspect, in the image forming apparatus of the first aspect, the verification condition includes the image forming apparatus, a recording medium, the evaluation item, the tolerance value, and the color information of the intended printing standard.

According to a third aspect, the image forming apparatus of the first or second aspect further includes a maintenance execution unit that executes a maintenance process to resolve the issue. The maintenance execution unit executes the maintenance process when the handling method determined by the handling method determination unit is the maintenance process executable by the maintenance execution unit.

According to a fourth aspect, in the image forming apparatus of any one of the first to third aspects, the handling method storage unit further stores, for each evaluation item, the number of times the handling method is performed, the number of resolutions, and the solution contribution rate. The handling method determination unit determines, as the handling method, a handling method with a higher solution contribution rate from multiple handling methods.

According to a fifth aspect, in the image forming apparatus of any one of the first to third aspects, the handling method storage unit further stores a processing time for the handling method. The handling method determination unit determines, as the handling method, a handling method with a shorter processing time from multiple handling methods.

According to a sixth aspect, in the image forming apparatus of any one of the first to third aspects, the handling method storage unit further stores a manufacturer's recommended order of handling methods for each evaluation item. The handling method determination unit determines, as the handling method, a handling method recommended by a manufacturer from multiple handling methods, according to the manufacturer's recommended order.

According to a seventh aspect, the image forming apparatus of any one of the fourth to sixth aspects further includes a handling mode designation unit that allows a user to designate a handling mode in advance to determine the handling method from the multiple handling methods. The handling method determination unit determines the handling method from the multiple handling methods based on the handling mode designated through the handling mode designation unit.

According to an eighth aspect, the image forming apparatus of any one of the third to seventh aspects further includes a maintenance execution setting unit that presets, when the handling method is the maintenance process executable by the maintenance execution unit, whether to automatically execute the maintenance process or to execute the maintenance process in response to a user instruction indicating whether to execute the maintenance process.

According to a ninth aspect, in the image forming apparatus of any one of the first to eighth aspect, in a case where the failed evaluation item is not resolved even when all the handling methods are performed, the handling method display unit displays a message recommending contact with a service of a manufacturer of the image forming apparatus.

According to a tenth aspect, the image forming apparatus of any one of the fourth, seventh, eighth, and ninth aspects further includes a cloud information storage unit that stores, on a cloud, the number of times the handling method is performed, the number of resolutions, and the solution contribution rate. The handling method determination unit acquires information of the same model as the model of the image forming apparatus subjected to the color reproducibility verification from the cloud information storage unit, the information indicating the number of times the handling method is performed, the number of resolutions, and the solution contribution rate, to determine the handling method based on the acquired information.

According to an eleventh aspect, a handling method, performed when color reproducibility verification performed by an image forming apparatus fails, includes steps of storing color reproducibility verification data, calculating, determining, storing a result, storing a handling method, determining a handling method, and displaying. The step of storing color reproducibility verification data includes storing evaluation items for color reproducibility verification, a tolerance value for each evaluation item, an evaluation chart, and color information of an intended printing standard. The step of calculating includes calculating an evaluation result for each evaluation item based on a color measurement value of the evaluation chart and the color information of the intended printing standard. The step of determining includes comparing the calculated evaluation result with the tolerance value and determining pass or fail. The step of storing a result includes storing a result of the step of determining and the number of determinations for each verification condition for color reproducibility verification. The step of storing a handling method includes storing, for each evaluation item, a handling method to resolve an issue that has caused the color reproducibility verification under the verification condition to fail, for a case in which the color reproducibility verification under the verification condition has never passed, and for a case in which the color reproducibility verification under the verification condition has passed once or more before. The step of determining a handling method includes determining a handling method for a failed evaluation item based on the information stored in the determination result storage unit and the information stored in the handling method storage unit. The step of displaying includes notifying a user of the handling method determined by the step of determining a handling method.

According to a twelfth aspect, a program causes a computer to function as a color reproducibility verification data storage unit, an evaluation result calculation unit, a determination unit, a determination result storage unit, a handling method storage unit, a handling method determination unit, and a handling method display unit. The color reproducibility verification data storage unit stores evaluation items for color reproducibility verification, a tolerance value for each evaluation item, an evaluation chart, and color information of an intended printing standard. The evaluation result calculation unit calculates an evaluation result for each evaluation item based on a color measurement value of the evaluation chart and the color information of the intended printing standard. The determination unit compares the calculated evaluation result with the tolerance value and determines pass or fail. The determination result storage unit stores a result of determination by the determination unit and the number of determinations for each verification condition for the color reproducibility verification. The handling method storage unit stores, for each evaluation item, a handling method to resolve an issue that has caused the color reproducibility verification under the verification condition to fail, for a case in which the color reproducibility verification under the verification condition has never passed, and for a case in which the color reproducibility verification under the verification condition has passed once or more before. The handling method determination unit determines a handling method for a failed evaluation item based on the information stored in the determination result storage unit and the information stored in the handling method storage unit. The handling method display unit notifies a user of the handling method determined by the handling method determination unit.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image forming engine to output an image; and
circuitry configured to:
store, in a memory, a verification condition including an evaluation item for color reproducibility verification, a tolerance value for the evaluation item, an evaluation chart, and color information of an intended printing standard;
calculate an evaluation result for the evaluation item based on a color measurement value of the evaluation chart and the color information of the intended printing standard;
compare the calculated evaluation result with the tolerance value to generate a determination result indicating pass or fail;
store, in the memory, the determination result and number of determinations for the verification condition;
store in the memory, a handling method for the evaluation item to resolve an issue that has caused the color reproducibility verification under the verification condition to fail, for a case in which the color reproducibility verification under the verification condition has never passed, and for a case in which the color reproducibility verification under the verification condition has passed once or more before;
determine a handling method for the evaluation item when the evaluation item fails, based on the stored information; and
notify a user of the determined handling method.

2. The image forming apparatus according to claim 1,
wherein the verification condition includes the image forming apparatus, a recording medium, the evaluation item, the tolerance value, and the color information of the intended printing standard.

3. The image forming apparatus according to claim 1,
wherein the circuitry is further configured to execute a maintenance process to resolve the issue when the determined handling method is the maintenance process executable by the image forming apparatus.

4. The image forming apparatus according to claim 1,
wherein the circuitry is configured to:
store, in the memory, number of times the handling method is performed, number of resolutions, and a solution contribution rate for the evaluation item; and
determine, as the handling method, a handling method with a higher solution contribution rate from multiple handling methods.

5. The image forming apparatus according to claim 1,
wherein the circuitry is configured to:
store, in the memory, a processing time for the handling method; and
determine, as the handling method, a handling method with a shorter processing time from multiple handling methods.

6. The image forming apparatus according to claim 1,
wherein the circuitry is configured to:
store, in the memory, a manufacturer's recommended order of handling methods for the evaluation item; and
determine, as the handling method, a handling method recommended by a manufacturer from multiple handling methods, according to the manufacturer's recommended order.

7. The image forming apparatus according to claim 4,
wherein the circuitry is configured to determine the handling method from the multiple handling methods based on a handling mode designated by a user in advance.

8. The image forming apparatus according to claim 3,
wherein the circuitry is further configured to preset, when the handling method is the maintenance process executable by the image forming apparatus, whether to automatically execute the maintenance process or to execute the maintenance process in response to a user instruction indicating whether to execute the maintenance process.

9. The image forming apparatus according to claim 1,
wherein, when the evaluation item fails and the issue is not resolved by the handling method, the circuitry is configured to display, on a display, a message recommending contact with a service of a manufacturer of the image forming apparatus.

10. The image forming apparatus according to claim 4,
wherein the circuitry is configured to store, on a cloud, information of a same model as a model of the image forming apparatus subjected to the color reproducibility verification, the information indicating the number of times the handling method is performed, the number of resolutions, and the solution contribution rate, to determine the handling method based on the stored information.

11. A method of determining a handling method, comprising:
storing, in a memory, an evaluation item for color reproducibility verification, a tolerance value for the evaluation item, an evaluation chart, and color information of an intended printing standard;
calculating an evaluation result for the evaluation item based on a color measurement value of the evaluation chart and the color information of the intended printing standard;
comparing the calculated evaluation result with the tolerance value to generate a determination result indicating pass or fail;
storing, in the memory, the determination result and number of determinations for a verification condition for the color reproducibility verification;
storing, in the memory, a handling method for the evaluation item to resolve an issue that has caused the color reproducibility verification under the verification condition to fail, for a case in which the color reproducibility verification under the verification condition has never passed, and for a case in which the color reproducibility verification under the verification condition has passed once or more before;
determining a handling method for the evaluation item when the evaluation item fails, based on the stored information; and
notifying a user of the determined handling method.

12. A non-transitory recording medium storing a plurality of instructions which, when executed by one or more processors, causes the one or more processors to perform a handling method, the method comprising:
storing, in a memory, an evaluation item for color reproducibility verification, a tolerance value for the evaluation item, an evaluation chart, and color information of an intended printing standard;
calculating an evaluation result for the evaluation item based on a color measurement value of the evaluation chart and the color information of the intended printing standard;
comparing the calculated evaluation result with the tolerance value to generate a determination result indicating pass or fail;
storing, in the memory, the determination result and number of determinations for a verification condition for the color reproducibility verification;
storing, in the memory, a handling method for the evaluation item to resolve an issue that has caused the color reproducibility verification under the verification condition to fail, for a case in which the color reproducibility verification under the verification condition has never passed, and for a case in which the color reproducibility verification under the verification condition has passed once or more before;
determining a handling method for the evaluation item when the evaluation item fails, based on the stored information; and
notifying a user of the determined handling method.
